(19) United States
(12) Patent Application Publication
(10) Pub. No.: US 2026/0202702 A1
(43) Pub. Date: Jul. 16, 2026

(54) NONLINEAR PERFECT VECTOR BEAM GENERATION ELEMENT, PREPARATION METHOD AND APPLICATION THEREOF

(71) Applicant: NANJING UNIVERSITY, Nanjing City (CN)

(72) Inventors: Lingling MA, Nanjing City (CN); Yanqing LU, Nanjing City (CN); Guangyang ZHANG, Nanjing City (CN); Yong YE, Nanjing City (CN); Zeyu WANG, Nanjing City (CN); Jintao PAN, Nanjing City (CN); Yu WANG, Nanjing City (CN)

(21) Appl. No.: 19/448,786

(22) Filed: Jan. 14, 2026

(30) Foreign Application Priority Data
Jan. 16, 2025 (CN) 202510068059.2

(51) Int. Cl. G02F 1/1337; G02F 1/141

(52) U.S. Cl. CPC G02F 1/133788; G02F 1/133711; G02F 1/141

(57) ABSTRACT

A nonlinear perfect vector beam generation element and a preparation method thereof are provided. The element includes a first glass substrate, a first photoalignment layer, a ferroelectric nematic liquid crystal layer, a second photoalignment layer and a second glass substrate. The first glass substrate and the second glass substrate are arranged oppositely. The first photoalignment layer and the second photoalignment layer are respectively disposed on inner sides of the first glass substrate and the second glass substrate. The first photoalignment layer and the second photoalignment layer are provided with a nonlinear perfect vector beam control pattern. The nonlinear perfect vector beam control pattern controls liquid crystal molecules in the ferroelectric nematic liquid crystal layer to exhibit a concentric ring alignment distribution of multiple periods.

### CROSS-REFERENCE TO RELATED APPLICATIONS

This application claims priority to Chinese Patent Application No. 202510068059.2, filed on Jan. 16, 2025, the contents of which are hereby incorporated by reference.

### TECHNICAL FIELD

The present disclosure belongs to the technical field of nonlinear optics, and specifically relates to a nonlinear perfect vector beam generation element, a preparation method and an application thereof.

### BACKGROUND

A vector beam is a structured light field with programmable vector distribution properties. The vector beam has already demonstrated significant application value in multiple fields such as optical communication, high-resolution imaging, and micromanipulation. Recently, the concept of a perfect vector beam has been proposed. This beam's annular intensity distribution is not directly related to its topological charge, and the topological charge may be arbitrarily encoded. It is noteworthy that perfect vector beams with different topological charges constitute a series of orthogonal bases, ensuring extremely low crosstalk among these beams. Based on this characteristic, in theory, a perfect vector beam may carry an infinite number of topological charges during transmission, thereby offering new possibilities for significantly enhancing communication capacity in the field of optical communication, and also making the storage and transmission of high-density optical information more efficient and reliable.

Currently, various methods such as combining linear diffraction elements and using spatial light modulators have been proposed to generate such perfect vector beams. Existing research primarily focuses on the generation and control of linear perfect vector beams, while studies on encoding perfect vector beams simultaneously during nonlinear frequency conversion are relatively scarce. The main reason is the difficulty in freely orienting and manipulating electric dipoles. Research on encoding perfect vector beams simultaneously during nonlinear frequency conversion holds significant theoretical and practical importance. It may not only efficiently utilize the degree of freedom of light frequency to enhance the transmission capacity and flexibility of communication systems, but also leverage the orthogonal basis characteristics to reduce crosstalk between signals, thereby improving system robustness and stability. Furthermore, this technology provides new tools and methods for designing novel photonic devices and conducting fundamental scientific research on light-matter interactions. This technology drives technological innovation and development in fields such as optical communication, quantum information processing, and super-resolution imaging. For the widely used uniaxial ferroelectric crystal elements, due to the phase matching condition being sensitive to the polarization direction of the electric vector, their vector characteristics are erased during direct nonlinear frequency conversion, and complex optical systems with multiple superimposed elements are generally required for implementation.

Therefore, developing a new nonlinear perfect vector beam generation element is of great significance.

### SUMMARY

The present disclosure aims to address current issues such as the complex optical systems requiring superposition of multiple elements for generating nonlinear perfect vector beams and the difficulty in orienting and manipulating electric dipoles. The present disclosure proposes a nonlinear perfect vector beam generation element prepared by utilizing structured alignment of liquid crystals. The element may achieve integration and miniaturization of the nonlinear perfect vector beam device and direct generation of nonlinear perfect vector beams.

The present disclosure further aims to address the preparation method for the aforementioned nonlinear perfect vector beam generation element.

To solve the above technical problems, the present disclosure provides a nonlinear perfect vector beam generation element. The element includes a first glass substrate, a first photoalignment layer, a ferroelectric nematic liquid crystal layer, a second photoalignment layer and a second glass substrate. The first glass substrate and the second glass substrate are arranged oppositely. The first photoalignment layer and the second photoalignment layer are respectively disposed on inner sides of the first glass substrate and the second glass substrate. Spacer particles are arranged between the first photoalignment layer and the second photoalignment layer.

The first photoalignment layer and the second photoalignment layer are provided with a nonlinear perfect vector beam control pattern. The nonlinear perfect vector beam control pattern controls liquid crystal molecules in the ferroelectric nematic liquid crystal layer to exhibit a concentric ring alignment distribution of multiple periods.

Specifically, the spacer particles are used to control the distance between the first photoalignment layer and the second photoalignment layer.

Specifically, the first photoalignment layer, the second photoalignment layer and the spacer particles form a liquid crystal cell after encapsulation. The liquid crystal cell forms a ferroelectric nematic liquid crystal layer after injection of a ferroelectric nematic liquid crystal material.

In the present disclosure, configuring the first and second photoalignment layers with the nonlinear perfect vector beam control pattern may correspond to nonlinear perfect vector beams with different topological charges, but is not limited to these topological charges, including nonlinear perfect vector beams corresponding to any topological charge.

Optionally, the nonlinear perfect vector beam control pattern controls the diameter of the nonlinear perfect vector beam by controlling the size of the ring period.

Optionally, the nonlinear perfect vector beam control pattern consists of two concentric ring alignment distributions within a single period, and an alignment angle difference between adjacent rings is 90 degrees. The nonlinear perfect vector beam control pattern controls the intensity of the nonlinear perfect vector beam by controlling the width ratio of the two concentric rings within a single period.

Optionally, a molecular alignment rotation angle of a single ring within a single period of the nonlinear perfect vector beam control pattern is an arbitrary angle. The nonlinear perfect vector beam control pattern controls the topological charge of the nonlinear perfect vector beam by controlling the molecular alignment rotation angle of a single ring.

Specifically, in the embodiment of the present disclosure, by controlling the molecular alignment rotation angles of a single ring in the nonlinear perfect vector beam control pattern to be 360 degrees, 540 degrees, 720 degrees, and 1080 degrees respectively, nonlinear perfect vector beams with topological charges of 2, 3, 4, and 6 are respectively achieved.

The present disclosure further provides a preparation method for the aforementioned nonlinear perfect vector beam generation element, with specific steps as follows:
step 1, ultrasonically cleaning and drying a first glass substrate and a second glass substrate followed by ultraviolet ozone cleaning;
step 2, spin-coating a photoalignment agent on the cleaned first glass substrate and second glass substrate after the step 1, and curing to form a first photoalignment layer and a second photoalignment layer;
step 3, applying spacer particles on two sides of the first photoalignment layer, then placing the second photoalignment layer thereon and encapsulating to form a liquid crystal cell;
step 4, performing polarized ultraviolet exposure alignment on the first photoalignment layer and the second photoalignment layer to form a nonlinear perfect vector beam control pattern; and
step 5, injecting a ferroelectric nematic liquid crystal material into the liquid crystal cell to form a ferroelectric nematic liquid crystal layer, thereby obtaining the nonlinear perfect vector beam generation element.

Specifically, the photoalignment agent is an azobenzene-based photoalignment material sulfonic acid dye 1 (SD1).

Specifically, the ferroelectric nematic liquid crystal material is a ferroelectric nematic liquid crystal material containing an intermediate polar phase.

Optionally, the ferroelectric nematic liquid crystal material is 4-((4-nitrophenoxy)carbonyl)-3-(trifluoromethyl)phenyl 2-fluoro-4-methoxybenzoate.

Specifically, in the step 1, the ultrasonic cleaning includes ultrasonic cleaning with an ethanol alcohol cleaning solution and ultrasonic cleaning with ultrapure water.

Optionally, the ultrasonic cleaning with the ethanol alcohol cleaning solution lasts for 20 minutes. The ultrasonic cleaning with ultrapure water is performed twice, each time lasting for 10 minutes.

Specifically, in the step 1, the drying is performed at a temperature of 140 degrees Celsius for 40 minutes.

Specifically, in the step 1, the ultraviolet ozone cleaning lasts for 30 minutes.

Specifically, in the step 2, parameters for the spin-coating are: a first-step spin-coating speed of 3000 revolutions per minute, and a first-step spin-coating duration of 40 seconds; and a second-step spin-coating speed of 300 revolutions per minute, and a second-step spin-coating duration of 10 seconds.

Specifically, in the step 2, conditions for the curing are: curing at 100 degrees Celsius for 10 minutes.

Specifically, in the step 3, the spacer particles are silica microspheres.

In an embodiment, an application of the aforementioned nonlinear perfect vector beam generation element in generating a nonlinear perfect vector beam also falls within the protection scope of the present disclosure.

Specifically, in the embodiment of the present disclosure, the nonlinear perfect vector beam generation element described in the present disclosure may simultaneously achieve frequency doubling and vector field transformation for incident fundamental frequency Gaussian light. During nonlinear frequency conversion, the original fundamental frequency Gaussian mode is converted into a perfect vector beam, and by configuring different nonlinear perfect vector beam control patterns, the generation of nonlinear perfect vector beams with topological charges of 2, 3, 4, and 6 is respectively achieved.

The disclosure has the following beneficial effects. The present disclosure achieves integration and miniaturization of a nonlinear perfect vector beam device and direct one-step generation of a nonlinear perfect vector beam through direct alignment of liquid crystal electric dipoles.

### BRIEF DESCRIPTION OF THE DRAWINGS

The following further describes the present disclosure in detail with reference to the accompanying drawings and the specific embodiment, and the above and/or other advantages of the present disclosure will become clearer.

FIG. 1 is a structural diagram of the nonlinear perfect vector beam generation element prepared in the present disclosure.

FIG. 2 is a schematic diagram of the molecular alignment of the nonlinear perfect vector beam generation element prepared in the present disclosure.

FIG. 3 is a texture diagram of the nonlinear perfect vector beam generation element prepared in the present disclosure under a polarizing microscope.

FIG. 4 is a schematic diagram of the generation process of the nonlinear perfect vector beam prepared in the present disclosure.

FIG. 5 is a beam analysis of the nonlinear perfect vector beam prepared in the present disclosure with a topological charge equal to 2.

FIG. 6A is a schematic diagram of the molecular alignment of the nonlinear perfect vector beam generation element corresponding to the nonlinear perfect vector beam with a topological charges equal to 3 prepared in the present disclosure.

FIG. 6B is a schematic diagram of the molecular alignment of the nonlinear perfect vector beam generation element corresponding to the nonlinear perfect vector beam with a topological charges equal to 4 prepared in the present disclosure.

FIG. 6C is a schematic diagram of the molecular alignment of the nonlinear perfect vector beam generation element corresponding to the nonlinear perfect vector beam with a topological charges equal to 6 prepared in the present disclosure.

FIG. 7A shows the nonlinear perfect vector beam with a topological charge equal to 3 prepared in the present disclosure.

FIG. 7B shows the nonlinear perfect vector beam with a topological charge equal to 4 prepared in the present disclosure.

FIG. 7C shows the nonlinear perfect vector beam with a topological charge equal to 6 prepared in the present disclosure.

FIG. 8 is a flowchart of the preparation method for the nonlinear perfect vector beam generation element according to the present disclosure.

### DETAILED DESCRIPTION OF THE EMBODIMENT

The present disclosure is further described in detail below with reference to the accompanying drawings and the embodiment. It is to be understood that the specific embodiment described herein is only for explaining the present disclosure and is not intended to limit the present disclosure. It should also be noted that, for ease of description, only parts related to the present disclosure rather than the entire structure are shown in the drawings.

In the following embodiment, the synthetic route for the ferroelectric nematic liquid crystal material 4-((4-nitrophenoxy)carbonyl)-3-(trifluoromethyl)phenyl 2-fluoro-4-methoxybenzoate (NJU001) is as follows:

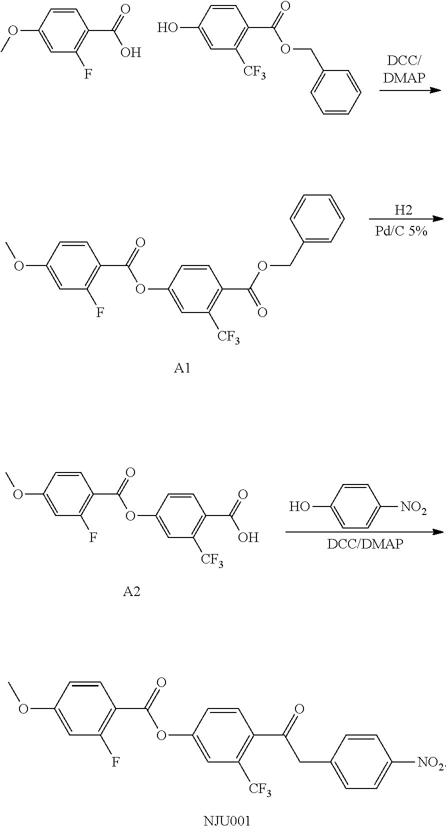

The specific steps are as follows.

Synthesis of A1: 8.5 grams (50 millimoles) of 2-fluoro-4-methoxybenzoic acid, 15 grams (50 millimoles) of benzyl 2-(trifluoromethyl)-4-hydroxybenzoate, 0.2 grams of 4-dimethylaminopyridine (DMAP), and 100 milliliters of dichloromethane (DCM) are added into a 250 milliliters three-necked flask. The mixture is cooled to 5 degrees Celsius under stirring. Then a solution of N,N′-Dicyclohexylcarbodiimide (DCC) (12.5 grams (60 millimoles) of DCC dissolved in 30 milliliters of DCM) is added dropwise while maintaining a temperature of 5-10 degrees Celsius. After the dropwise addition is completed, the reaction is maintained for 12 hours. The mixture is filtered. The filtrate is washed with 50 milliliters of 1% hydrochloric acid. The DCM layer is collected, dried over anhydrous magnesium sulfate, concentrated to remove DCM, and 50 milliliters of ethanol is added for crystallization to obtain 18.4 grams (41 millimoles) of A1, with a yield of 82.14%.

Synthesis of A2: 15 grams (33 millimoles) of A1, 50 milliliters of tetrahydrofuran are added into a 100 milliliters hydrogenation autoclave. Then 1 gram of 5% palladium on carbon is added. After hydrogen replacement (0.1 megapascal), the hydrogenation reaction is carried out for 12 hours. Nitrogen is used to replace the atmosphere in the autoclave. The mixture is filtered to remove the palladium on carbon, concentrated to remove tetrahydrofuran, and 50 milliliters of ethanol is added for crystallization to obtain 10.4 grams (28.1 millimoles) of A2, with a yield of 85.11%.

Synthesis of NJU001: 8 grams (22 millimoles) of A2, 3.4 grams (24.5 millimoles) of p-nitrophenol, 0.1 gram of DMAP, and 100 milliliters of DCM are added into a 250 milliliters three-necked flask. The mixture is cooled to 5 degrees Celsius. A DCM solution of DCC (5.53 grams in 20 milliliters of DCM) is added dropwise. After the dropwise addition is completed, the reaction is maintained for 12 hours. The mixture is filtered. The filtrate is washed with 50 milliliters of 1% hydrochloric acid, dried over anhydrous magnesium sulfate, concentrated to remove DCM, and then subjected to rapid column chromatography for purification, followed by crystallization with ethanol to obtain 4.8 grams (10 millimoles) of NJU001. The purity is 99.3%, and the yield is 44.8%.

### Embodiment

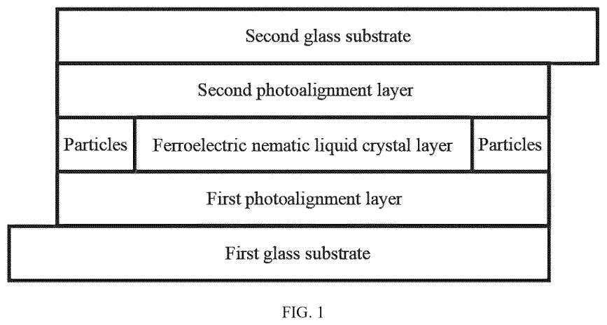

An embodiment of the present disclosure provides a nonlinear perfect vector beam generation element. FIG. 1 is a structural diagram of the liquid crystal element provided by the present disclosure, which specifically includes a first glass substrate and a second glass substrate arranged oppositely. A first photoalignment layer and a second photoalignment layer, which are formed by spin-coating a photoalignment agent followed by curing, are respectively disposed on inner sides of the first glass substrate and the second glass substrate. Spacer particles are arranged on two sides between the first photoalignment layer and the second photoalignment layer. After curing, a liquid crystal cell is formed by the first photoalignment layer, the second photoalignment layer, and the spacer particles arranged on the two sides, and a ferroelectric nematic liquid crystal layer is formed after liquid crystal material is injected.

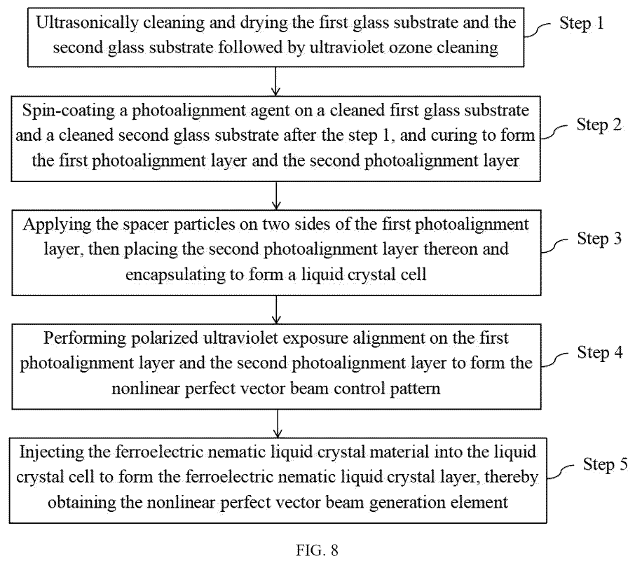

As shown in FIG. 8, an embodiment of the present disclosure further provides a preparation method for a nonlinear perfect vector beam generation element, and the specific steps are as follows.

First, a first glass substrate and a second glass substrate are ultrasonically cleaned with an anhydrous ethanol cleaning solution for 20 minutes. Then, the substrates are repeatedly ultrasonically cleaned twice with ultrapure water, each cleaning time being 10 minutes. The cleaned substrates are placed in a drying oven, the temperature of the drying oven is set to 140 degrees Celsius, and the drying time is 40 minutes. Finally, the first glass substrate and the second glass substrate are subjected to ultraviolet ozone cleaning for 30 minutes.

Subsequently, a photoalignment agent sulfonic acid dye 1 (SD1) is spin-coated on the first glass substrate and the second glass substrate. The spin-coating method is as follows. The speed for the first step of spin-coating is 3000 revolutions per minute, and the spin-coating time is 40 seconds. The speed for the second step of spin-coating is 300 revolutions per minute, and the spin-coating time is 10 seconds. After the photoalignment layers made of the selected SD1 material are spin-coated on the first glass substrate and the second glass substrate through the spin-coating operation, the first glass substrate and the second glass substrate are placed on a hot plate at a temperature of 100 degrees Celsius to cure the photoalignment layers. The curing time is 10 minutes. After curing, a first photoalignment layer is formed on the side of the first glass substrate and a second photoalignment layer is formed on the side of the second glass substrate.

Silica microspheres mixed with ultraviolet sealant are selected as spacers. The mixture is uniformly applied to both sides of the first photoalignment layer. Then the second glass substrate with the second photoalignment layer formed thereon is placed facing the spacer particles for encapsulation. The first and second glass substrates are bonded in a staggered manner (FIG. 1), and placed under ultraviolet light until the sealant is cured, forming a liquid crystal cell. The cell thickness of the embodiment is controlled by changing the diameter of the silica microspheres, and the cell thickness of the liquid crystal cell in the embodiment is measured by interferometry.

Polarized ultraviolet exposure alignment is performed on the first photoalignment layer and the second photoalignment layer. An azobenzene-based photoalignment material SD1 is selected as the alignment agent for the first photoalignment layer and the second photoalignment layer. Under irradiation with linearly polarized light. The molecules of the photoalignment material are aligned in a direction perpendicular to the direction of the linearly polarized light, and through interaction with liquid crystal molecules, the liquid crystal molecules are induced to form a specifically designed ordered alignment. A liquid crystal material is injected between the first glass substrate and the second glass substrate. The novel ferroelectric nematic liquid crystal material NJU001 is heated to 150 degrees Celsius and injected into the liquid crystal cell through a capillary glass tube, thereby obtaining the nonlinear perfect vector beam generation element.

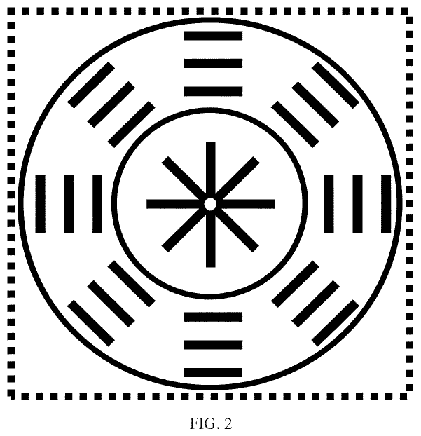

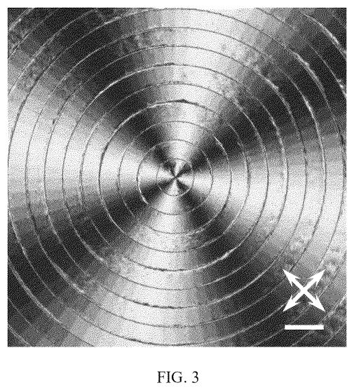

FIG. 2 is a schematic diagram of the liquid crystal molecular alignment of the nonlinear perfect vector beam generation element prepared in the present disclosure. The diagram illustrates the alignment distribution of liquid crystal molecules within the first period of the nonlinear perfect vector beam control pattern. Each period consists of two concentric ring alignment distributions of equal width, and the alignment angle difference between adjacent rings is 90 degrees. FIG. 3 is a texture diagram of the nonlinear perfect vector beam generation element prepared in the present disclosure under a polarizing microscope.

Optionally, the ring period of the nonlinear perfect vector beam control pattern is not limited to the distribution shown in the figure. Nonlinear perfect vector beam control patterns with any period size will determine the diameter of the nonlinear perfect vector beam.

Optionally, the molecular alignment rotation angle of a single ring in the nonlinear perfect vector beam control pattern is not limited to 360 degrees as shown in the figure. Any rotation angle corresponds to a nonlinear perfect vector beam with a different topological charge.

Optionally, each period of the nonlinear perfect vector beam control pattern is not limited to consisting of two concentric ring alignment distributions of equal width. Any two concentric ring alignment distributions of unequal width determine the intensity of the nonlinear perfect vector beam.

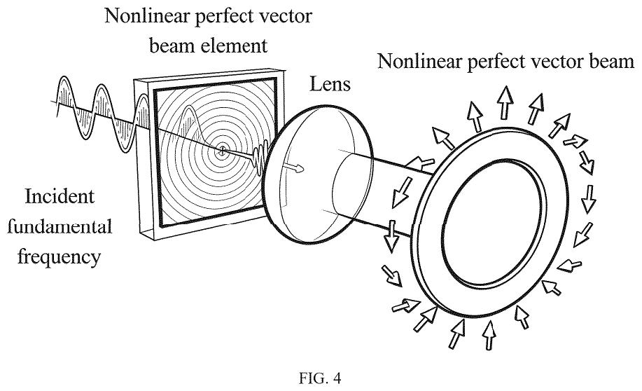

FIG. 4 is a schematic diagram of the beam generation process by the nonlinear perfect vector beam generation element prepared in the present disclosure. During the cooling process, the novel ferroelectric nematic liquid crystal NJU001 undergoes the following phase transitions. When the temperature is above 132 degrees Celsius, it is in an isotropic state. When the temperature is between 132 degrees Celsius and 76 degrees Celsius, it is in a nematic phase state. When the temperature is between 76 degrees Celsius and 58 degrees Celsius, it is in an intermediate polar phase state. When the temperature is below 58 degrees Celsius, it is in a ferroelectric nematic phase state. Generally, it is difficult to orient and manipulate electric dipoles in the ferroelectric nematic phase state. In the present disclosure, the intermediate polar phase state of NJU001 is selected, which allows good electric dipole control through photoalignment, and different nonlinear perfect vector beam control patterns are configured. After cooling to the intermediate polar phase state, the temperature is maintained constant, and a lens is placed after the nonlinear perfect vector beam generation element for imaging to obtain the nonlinear perfect vector beam.

Optionally, the novel ferroelectric nematic material NJU001 (4-((4-nitrophenoxy)carbonyl)-3-(trifluoromethyl)phenyl 2-fluoro-4-methoxybenzoate) is used, but the material is not limited to this. All materials belonging to this class of ferroelectric nematic materials containing an intermediate polar phase are included. This class of materials may maintain stable second-harmonic generation signals while exhibiting good photoalignment characteristics.

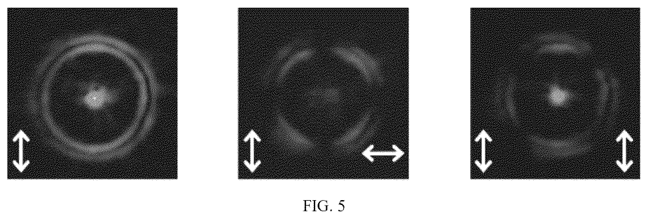

FIG. 5 is a beam analysis of the nonlinear perfect vector beam prepared in the present disclosure with a topological charge equal to 2. When a nonlinear perfect vector beam control pattern with a topological charge equal to 2 is configured, the emitted second-harmonic perfect vector beam is imaged at the focal point of the lens. When the topological charge of the emitted nonlinear perfect vector beam is equal to 2, and an analyzer is placed behind the beam, the corresponding nonlinear perfect vector beam is transformed into a four-lobe spot.

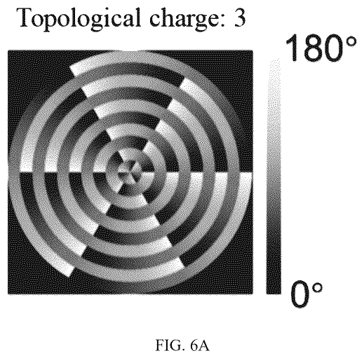

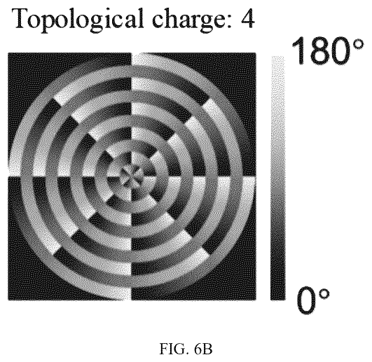

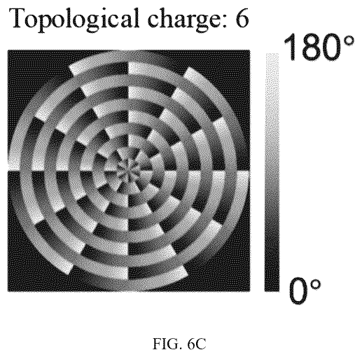

FIG. 6A, FIG. 6B, and FIG. 6C are schematic diagrams of the alignment of the nonlinear perfect vector beam generation elements corresponding to the nonlinear perfect vector beams with topological charges equal to 3, 4, and 6 prepared in the present disclosure. The molecular alignment rotation angles of a single ring are 540 degrees, 720 degrees, and 1080 degrees, respectively.

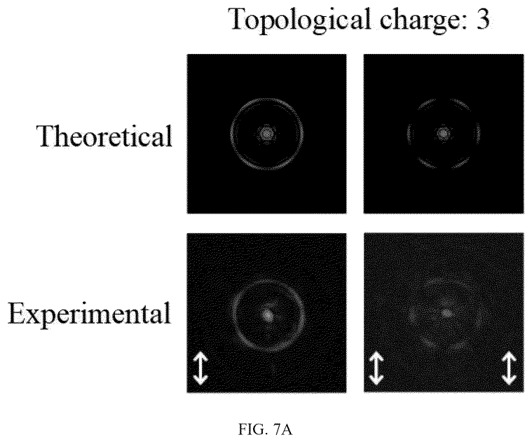

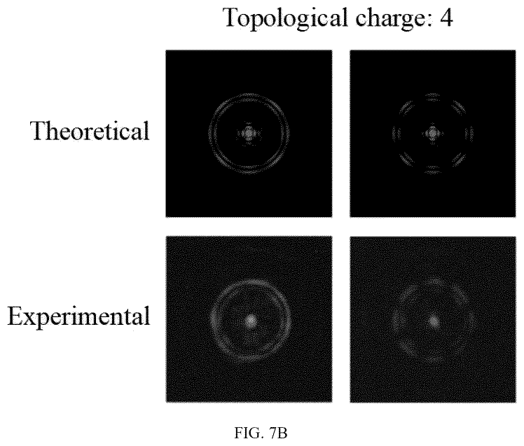

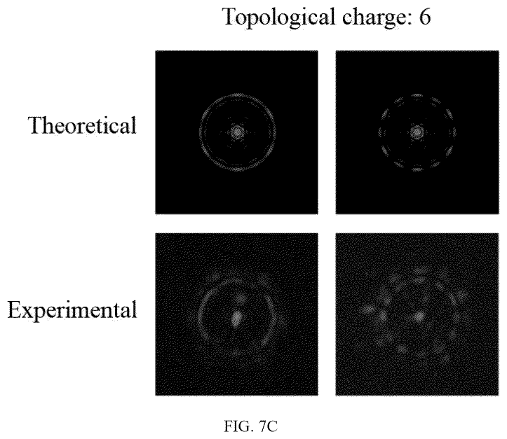

FIG. 7A, FIG. 7B, and FIG. 7C show the nonlinear perfect vector beams with different topological charges prepared in the present disclosure. Nonlinear perfect vector beam control patterns with topological charges equal to 3, 4, and 6 are configured, and the emitted second-harmonic perfect vector beams are imaged at the focal point of the lens. When the topological charges of the emitted nonlinear perfect vector beams are equal to 3, 4, and 6, and an analyzer is placed behind the beams, the corresponding nonlinear perfect vector beams are transformed into six-lobe, eight-lobe, and twelve-lobe spots, respectively.

Optionally, the present disclosure configures nonlinear perfect vector beams with topological charges equal to 2, 3, 4, and 6, but is not limited to these topological charges. Nonlinear perfect vector beams corresponding to larger or smaller topological charges are also included.

The present disclosure provides an approach for a nonlinear perfect vector beam generation element, a preparation method and an application thereof. Many methods and approaches for implementing this technical scheme exist, and the above description is only an optional embodiment of the present disclosure. It should be noted that, for those skilled in the art, multiple improvements and modifications may be made without departing from the principle of the present disclosure, and these improvements and modifications should also be regarded as falling within the protection scope of the present disclosure. All components not explicitly specified in this embodiment may be implemented using existing techniques.

What is claimed is:

1. A nonlinear perfect vector beam generation element, wherein the nonlinear perfect vector beam generation element comprises a first glass substrate, a first photoalignment layer, a ferroelectric nematic liquid crystal layer, a second photoalignment layer, and a second glass substrate; wherein the first glass substrate and the second glass substrate are arranged oppositely; the first photoalignment layer and the second photoalignment layer are respectively disposed on inner sides of the first glass substrate and the second glass substrate; and spacer particles are arranged between the first photoalignment layer and the second photoalignment layer; and
wherein the first photoalignment layer and the second photoalignment layer are provided with a nonlinear perfect vector beam control pattern; the nonlinear perfect vector beam control pattern controls liquid crystal molecules in the ferroelectric nematic liquid crystal layer to exhibit a concentric ring alignment distribution of a plurality of periods; and a ferroelectric nematic liquid crystal material of the ferroelectric nematic liquid crystal layer is a ferroelectric nematic liquid crystal material comprising an intermediate polar phase.

2. The nonlinear perfect vector beam generation element according to claim 1, wherein the nonlinear perfect vector beam control pattern comprises two concentric ring alignment distributions within a single period, and an alignment angle difference between adjacent rings is 90 degrees.

3. The nonlinear perfect vector beam generation element according to claim 1, wherein a molecular alignment rotation angle of a single ring within a single period of the nonlinear perfect vector beam control pattern is an arbitrary angle.

4. A preparation method for the nonlinear perfect vector beam generation element according to claim 1, wherein specific steps are:
step 1, ultrasonically cleaning and drying the first glass substrate and the second glass substrate followed by ultraviolet ozone cleaning;
step 2, spin-coating a photoalignment agent on a cleaned first glass substrate and a cleaned second glass substrate after the step 1, and curing to form the first photoalignment layer and the second photoalignment layer;
step 3, applying the spacer particles on two sides of the first photoalignment layer, then placing the second photoalignment layer thereon and encapsulating to form a liquid crystal cell;
step 4, performing polarized ultraviolet exposure alignment on the first photoalignment layer and the second photoalignment layer to form the nonlinear perfect vector beam control pattern; and
step 5, injecting the ferroelectric nematic liquid crystal material into the liquid crystal cell to form the ferroelectric nematic liquid crystal layer, thereby obtaining the nonlinear perfect vector beam generation element.

5. The preparation method according to claim 4, wherein the photoalignment agent is an azobenzene-based photoalignment material sulfonic acid dye 1 (SD1).

6. The preparation method according to claim 4, wherein the ferroelectric nematic liquid crystal material is 4-((4-nitrophenoxy)carbonyl)-3-(trifluoromethyl)phenyl 2-fluoro-4-methoxybenzoate.

7. The preparation method according to claim 4, wherein in the step 2, parameters for the spin-coating are: a first-step spin-coating speed of 3000 revolutions per minute, and a first-step spin-coating duration of 40 seconds; and a second-step spin-coating speed of 300 revolutions per minute, and a second-step spin-coating duration of 10 seconds.

8. The preparation method according to claim 4, wherein in the step 2, conditions for the curing are: curing at 100 degrees Celsius for 10 minutes.
